(19) United States
(12) Patent Application Publication
(10) Pub. No.: US 2026/0268776 A1
(43) Pub. Date: Sep. 10, 2026

(54) VEHICULAR DRIVING ASSIST SYSTEM WITH UNPARKING VEHICLE ALERT

(71) Applicant: Magna Electronics Inc., Auburn Hills, MI (US)

(72) Inventors: Jagadish Narayan Gowda, Bengaluru (IN); Dhanush Upadhya R., Bengaluru (IN)

(21) Appl. No.: 19/530,441

(22) Filed: Feb. 5, 2026

Related U.S. Application Data
(60) Provisional application No. 63/767,751, filed on Mar. 6, 2025.

(51) Int. Cl. G08G 1/16; G01S 13/931; G07C 5/02

(52) U.S. Cl. CPC G08G 1/166; G01S 13/931; G07C 5/02; G01S 2013/93271; G01S 2013/93272

(57) ABSTRACT

A vehicular driving assist system includes a plurality of radar sensors disposed at a vehicle. Each radar sensor senses exterior of the vehicle. Based on determination that the vehicle is moving from a parking space and toward a road, the system processes sensor data captured by a subset of radar sensors of the plurality of radar sensors, where the subset of radar sensors sense toward the road. At least in part via processing sensor data captured by the subset of radar sensors, the system detects presence of an object approaching the vehicle and the system generates an alert.

### CROSS REFERENCE TO RELATED APPLICATION

The present application claims the filing benefits of U.S. provisional application Ser. No. 63/767,751, filed Mar. 6, 2025, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of radar sensors in vehicle sensing systems is common and known.

Examples of such known systems are described in U.S. Pat. Nos. 9,146,898; 8,027,029 and/or 8,013,780, which are hereby incorporated herein by reference in their entireties.

### SUMMARY OF THE INVENTION

A driving assist system or sensing system or imaging system for a vehicle includes a plurality of radar sensors disposed at a vehicle equipped with the vehicular driving assist system. Each radar sensor of the plurality of radar sensors senses exterior of the vehicle, and each radar sensor of the plurality of radar sensors is operable to capture sensor data. An electronic control unit (ECU) includes electronic circuitry and associated software. The electronic circuitry includes a processor for processing sensor data captured by the plurality of radar sensors and transferred to the ECU. Based on determination that the vehicle is moving from a parking space and toward a road (i.e., is performing an unparking maneuver), the vehicular driving assist system processes sensor data captured by a subset of radar sensors of the plurality of radar sensors. The subset of radar sensors senses exterior of the vehicle and toward the road. Based on processing sensor data captured by the subset of radar sensors, the vehicular driving assist system detects presence of an object approaching vehicle. Based on detecting presence of the object approaching the vehicle, the vehicular driving assist system generates an alert to the detected object.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIG. 2 is a schematic view of the vehicle of FIG. 1 detecting presence of an approaching vehicle during an unparking maneuver; and

FIG. 3 is a flowchart of an example method of detecting presence of the approaching vehicle and operating a turn signal indicator to signal to the approaching vehicle during the unparking maneuver.

### DESCRIPTION OF THE PREFERRED EMBODIMENTS

A vehicle sensing system and/or driver or driving assist system and/or object detection system and/or alert system operates to capture images and/or sensor data exterior of the vehicle and may process the captured image data and/or sensor data to display images and/or to detect objects at or near the vehicle and in the predicted path of the vehicle, such as to assist a driver of the vehicle in maneuvering the vehicle in a rearward direction during a parking maneuver. The vision system includes a data processor for processing captured sensor data and an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

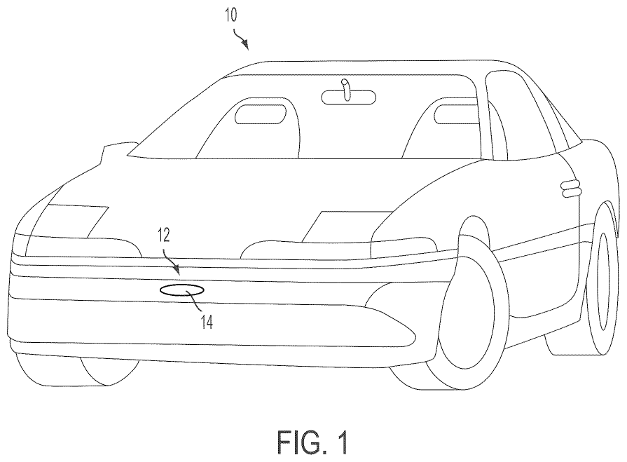

Referring now to the drawings and the illustrative embodiments depicted therein, a vehicle 10 (FIG. 1) includes a driving assist system or sensing system 12 that includes at least one radar sensor unit, such as a forward facing radar sensor unit 14 (and the system may optionally include multiple exterior facing sensors, such as cameras, radar, or other sensors, such as a rearward facing sensor at the rear of the vehicle, and a sideward/rearward facing sensor at respective sides of the vehicle), which sense regions exterior of the vehicle. The sensing system 12 includes a control or electronic control unit (ECU) that includes a data processor that is operable to process data captured by the radar sensor(s). The radar sensor includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle, with the driving assist system controlling at least one function or feature of the vehicle (such as to provide autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

The vehicle 10 may include a plurality of radar sensors 14 disposed about the vehicle 10 and operable to sense respective regions exterior of the vehicle 10. For example, the vehicle 10 includes a front driver-side radar sensor at a front driver-side corner region of the vehicle that is operable to sense a region exterior of the vehicle and at least forward of the vehicle and along the driver side of the vehicle. The vehicle 10 may also include a front passenger-side radar sensor at a front passenger-side corner region of the vehicle that is operable to sense a region exterior of the vehicle and at least forward of the vehicle and along the passenger side of the vehicle. A rear driver-side radar sensor at a rear driver-side corner region of the vehicle may be operable to sense a region exterior of the vehicle and at least rearward of the vehicle and along the driver side of the vehicle and a rear passenger-side radar sensor at a rear passenger-side corner region of the vehicle may be operable to sense a region exterior of the vehicle and at least rearward of the vehicle and along the passenger side of the vehicle. Collectively, sensor data captured by the radar sensors at the vehicle may be used by the driving assist system 12 during a parking maneuver and/or an unparking maneuver, such as to detect objects and other vehicles approaching the vehicle 10 when the vehicle 10 is maneuvering out of a parking space, as described further below.

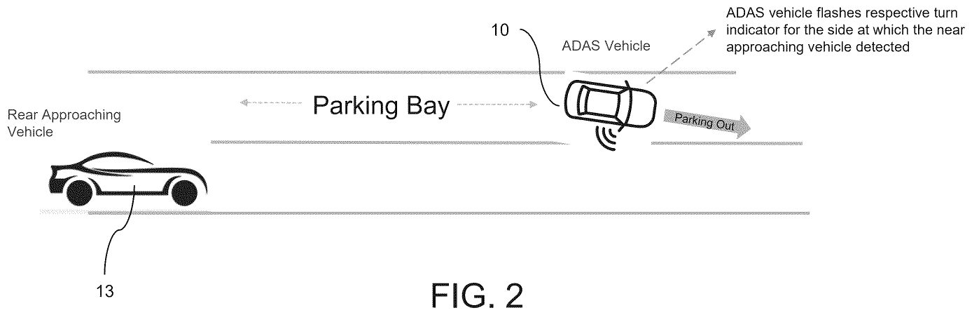

Referring to FIG. 2, during an unparking maneuver where the vehicle 10 is moving out of a parking space and toward a road (e.g., a lane of a road adjacent the parking space or a through lane of a parking lot), sensor data captured by the sensors (e.g., the corner radar sensors) is processed to determine presence of an object approaching the vehicle 10. In the illustrated example, the system detects presence of another vehicle 13 approaching the vehicle. The system 12 may also be configured to detect presence of pedestrians, bicycles, and other objects (e.g., shopping carts) approaching the vehicle.

Based on determining presence of the other vehicle 13, the driving assist system 12 generates an alert. For example, the system 12 may generate an alert to the driver of the vehicle, such as via an audible alert played within the cabin of the vehicle 10 (e.g., a tone or message played via a speaker system of the vehicle) or a visual alert displayed within the cabin of the vehicle 10 (e.g., a message displayed at a display screen of the vehicle, such as at a gauge cluster or infotainment screen, or illumination of an icon, like at the dashboard or gauge cluster).

Further, the system 12 may generate an alert exterior the vehicle 10, such as an audible alert (e.g., honking the horn of the vehicle) or a visual alert. For example, the system 12 may operate one or more exterior lights or signals or indicators of the vehicle 10, such as turn signal indicators of the vehicle, hazard light indicators of the vehicle, reverse light indicators of the vehicle, and the like, to alert a driver of the other vehicle 13 that the vehicle 10 is moving out of the parking space. For example, the system 12 may illuminate the turn signal indicator lights based on determining that the other vehicle 13 is approaching the vehicle 10 and that the vehicle 10 is moving toward or into an estimated path of travel of the other vehicle 13. Optionally, the driving assist system 12 may at least partially control operation of the vehicle 10 based on detection of the other vehicle 13, such as to initiate emergency braking and prevent the vehicle 10 from moving further toward the other vehicle 13 or path of travel of the other vehicle 13 until the other vehicle has moved past the vehicle 10.

The driving assist system 12 may determine that the vehicle 10 is performing an unparking maneuver based on vehicle kinematic data and/or sensor data captured by one or more other systems of the vehicle 10, such as based on determination that the vehicle 10 is stationary, based on determination that a gear selector or propulsion system of the vehicle is in a reverse or drive mode, and that a steering angle of the vehicle is toward a road. Determination of the road relative to the vehicle may be based on image data captured by one or more exterior-viewing cameras of the vehicle (such as one or more cameras that are part of a surround-vision system of the vehicle or a camera monitoring system of the vehicle). Optionally, the system 12 may determine that the vehicle 10 is performing the unparking maneuver based on a signal from an at least partially autonomous driving system of the vehicle 10 as the autonomous driving system controls operation of the vehicle to move the vehicle out of the parking space.

Further, the driving assist system 12 may determine a classification of the unparking maneuver and process sensor data from a subset of radar sensors based on the classification of the unparking maneuver. This may result in a reduced processing load and a more accurate detection of approaching objects as the system 12 only processes sensor data from the subset of radar sensors that sense toward the road. For example, based on determination that the vehicle 10 is performing an unparking maneuver from a parallel parking space (FIG. 2), the system 12 may process sensor data captured by a front corner radar sensor and a rear corner radar sensor along a side of the vehicle that is toward the road. That is, when the vehicle is parked in a parallel parking space and performing an unparking maneuver toward a driver side of the vehicle 10, the system 12 monitors sensor data captured by the front driver-side radar sensor and the rear driver-side radar sensor. The system 12 may determine that the vehicle 10 is performing the unparking maneuver from a parallel parking space based on, for example, determination that the vehicle is parked with other vehicles or objects near one or both of the front and rear ends of the vehicle. (e.g., based on image data captured by a camera monitoring system of the vehicle or based on radar sensor data captured by the plurality of radars), based on an input from the driver of the vehicle, and the like.

Based on determination that the vehicle 10 is performing an unparking maneuver from a perpendicular or horizontal parking space or from an angled parking space, the system 12 may process sensor data captured by either both rear corner radar sensors (e.g., for nose-in parking) or both front corner radar sensors (e.g., for rear-in parking). In other words, when the vehicle is parked in the perpendicular or angled parking space with the vehicle moving in a rearward direction out of the parking space (i.e., the vehicle is parked nose in), the system 12 monitors sensor data captured by the rear driver-side radar sensor and the rear passenger-side radar sensor. When the vehicle is parked in the perpendicular or angled parking space with the vehicle moving in a forward direction out of the parking space (i.e., the vehicle is parked rear in), the system 12 monitors sensor data captured by the front driver-side radar sensor and the front passenger-side radar sensor. The system 12 may determine that the vehicle 10 is performing the unparking maneuver from a perpendicular or angled parking space based on, for example, determination that the vehicle is parked with other vehicles or objects near one or more sides of the vehicle. (e.g., based on image data captured by a camera monitoring system of the vehicle or based on radar sensor data captured by the plurality of radars), based on an input from the driver of the vehicle, and the like.

The system may illuminate or actuate the exterior lights or signals of the vehicle (e.g., the turn signal indicators) to alert the approaching object or other vehicle 13 based on the classification of the unparking maneuver. For example, based on determining that the vehicle 10 is performing an unparking maneuver from a parallel parking space and moving into the road toward a driver side of the vehicle, the system 12 may illuminate the turn signal indicators at the driver side of the vehicle 10. Based on determining that the vehicle 10 is performing an unparking maneuver from a perpendicular or angled parking space, the system 12 may illuminate the turn signal indicators at the side of the vehicle at which the approaching vehicle 13 is detected and/or the system 12 may illuminate turn signal indicators at both sides of the vehicle (e.g., hazard lights). Further, the system 12 may activate the lights or indicators at the front of the vehicle 10 based on the vehicle 10 moving out of the perpendicular or angled parking space in a forward direction. The system 12 may activate the lights or indicators at the rear of the vehicle 10 based on the vehicle 10 moving out of the perpendicular or angled parking space in a rearward direction.

Optionally, the system 12 may illuminate the turn signal indicators to flash at a rate that is faster than normal (i.e., faster than the rate at which the indicators flash when the turn signal is actuated by the driver or by a lane change assist system when the vehicle is making a lane change while traveling along a road). That is, when the turn signal indicators are operated based on a user input, such as to signal a lane change or a turn during normal driving conditions as the vehicle travels along a road, the turn signal indicators may flash at a first rate. Based on the system 12 operating the turn signal indicators during the unparking maneuver, the turn signal indicators may flash at a second rate that is faster than the first rate. If the driver operates the turn signal indicators to indicate the unparking maneuver, the system 12 may increase the flashing of the turn signal indicators to the second rate based on detection of the approaching object.

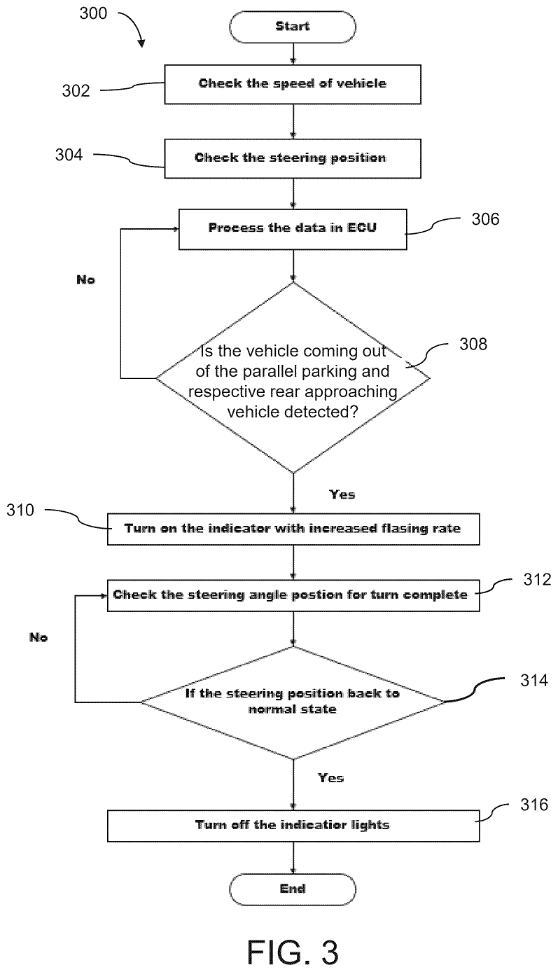

FIG. 3 depicts a flowchart of an exemplary method 300 of operating the driving assist system 12 to detect approaching vehicles during an unparking maneuver based on a subset of radar sensor data and operate the turn signal indicators at the side of the vehicle corresponding to the unparking maneuver. At operation 302 the method 300 includes checking the speed of the vehicle 10 and at operation 304 the method 300 includes checking the steering position of the vehicle 10. Based on determining that the vehicle speed is below a threshold speed (e.g., zero miles per hour, two miles per hour or less, five miles per hour or less, and the like) and that the steering position of the vehicle is toward a side of the vehicle, the method 300 includes processing sensor data captured by the radar sensors at operation 306. Optionally, the system 12 may only process sensor data captured by a subset of radar sensors corresponding to the unparking maneuver performed by the vehicle 10. At operation 308, the method 300 includes determining that the vehicle 10 is moving out of a parallel parking space and that another vehicle 13 is approaching (e.g., from a rearward direction). At operation 310, the method 300 includes operating the turn signal indicator at an increased flashing rate. At operation 312, the method 300 includes checking the steering angle position to determine if the unparking maneuver is complete. For example, at operation 314 the method 300 includes determining that the unparking maneuver is complete based on the steering position being back to a middle or normal or centered position. Optionally, the system 12 may determine that the unparking maneuver is complete based on the vehicle speed being greater than a threshold speed (e.g., zero miles per hour, five miles per hour or more, and the like). At operation 316, the method 300 includes turning off the indicator lights.

Thus, the system 12 provides a safety feature or parking turn assist for defensive driving. The vehicle's turn signal indicators are turned on with a flashing rate higher than a normal flashing rate, while taking out the vehicle from a parallel parking space if any oncoming objects from the sides are detected. This feature helps to notify other vehicles and to be cautious. This can be adapted for vehicles coming out of perpendicular parking as well.

In ADAS, the vehicle detects the oncoming vehicle while using rear corner radar or front corner radar while taking out from the parallel parking space. The vehicle moving out of the parking space may be detected by using vehicle speed and steering angle. The feature can be calibrated for the vehicle speed threshold and steering angle to determine that the vehicle is moving or making a turn.

The parking turn assist system may be integrated with the rear corner radar sensors and/or front corner radar sensors to detect the oncoming objects. The parking turn assist system may include a logical block that verifies that the vehicle is starting from stationary and/or taking a turn. For example, if the vehicle speed is zero (or below a threshold speed that is greater than zero), and if the steering angle is turned toward the right or left, the right or left corner radar may detect objects with respect to the side at which the steering wheel is turned. Then, the system flashes the respective right or left side indicator corresponding to the side at which the steering wheel is turned and with the object detected at the same side.

The feature may work without driver intervention to turn on the indicator to flash when it detects an oncoming object while coming out of parking. This may provide enhanced safety as it reduces the risk of accidents. It may provide better communication as it notifies the rear vehicle of the front vehicle maneuver. This may prevent rear-end collisions as it helps drivers behind the vehicle understand actions in a better way and avoid hitting the forward vehicle. This may reduce human error as it automatically turns on the indicators so there might not be any human intervention. It may make driving safer and easier by automatically alerting other drivers when the forward vehicle is about to make a turn from a stop. This reduces the chances of accidents and improves overall traffic flow.

Currently, drivers manually turn on their indicators, which they often forget to do. So, it improves on traditional manual indicators by automatically flashing the lights when the driver of a vehicle is about to make a turn from a stop. This reduces the chance of human error, like forgetting to use the turn indicators and makes the road safer.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The vehicle may include any type of sensor or sensors, such as imaging sensors or radar sensors or lidar sensors or ultrasonic sensors or the like. For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753, 121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The system may utilize aspects of the parking assist systems described in U.S. Pat. No. 8,874,317 and/or U.S. Publication Nos. US-2017-0329346; US-2017-0317748; US-2017-0253237; US-2017-0050672; US-2017-0017848; US-2017-0015312 and/or US-2015-0344028, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a plurality of radar sensors disposed at a vehicle equipped with the vehicular driving assist system, wherein each radar sensor of the plurality of radar sensors senses exterior of the vehicle, and wherein each radar sensor of the plurality of radar sensors is operable to capture sensor data;
an electronic control unit (ECU);
wherein sensor data captured by the plurality of radar sensors is transferred to the ECU;
wherein the ECU comprises electronic circuitry and associated software;
wherein the electronic circuitry of the ECU comprises a processor for processing sensor data captured by the plurality of radar sensors and transferred to the ECU;
wherein, based on determination that the vehicle is moving from a parking space and toward a road, the vehicular driving assist system processes sensor data captured by a subset of radar sensors of the plurality of radar sensors, and wherein the subset of radar sensors senses exterior of the vehicle and toward the road;
wherein, at least in part via processing sensor data captured by the subset of radar sensors, the vehicular driving assist system detects presence of an object approaching vehicle; and
wherein, responsive to detecting presence of the object approaching the vehicle, the vehicular driving assist system generates an alert.

2. The vehicular driving assist system of claim 1, wherein the plurality of radar sensors includes at least (i) a front driver-side radar sensor at a front driver-side corner region of the vehicle and sensing exterior of the vehicle and at least forward and along a driver side of the vehicle, (ii) a front passenger-side radar sensor at a front passenger-side corner region of the vehicle and sensing exterior of the vehicle and at least forward and along a passenger side of the vehicle, (iii) a rear driver-side radar sensor at a rear driver-side corner region of the vehicle and sensing exterior of the vehicle and at least rearward and along the driver side of the vehicle, (ii) a rear passenger-side radar sensor at a rear passenger-side corner region of the vehicle and sensing exterior of the vehicle and at least rearward and along the passenger side of the vehicle.

3. The vehicular driving assist system of claim 2, wherein, based on determination that the vehicle is moving from a parallel parking space, and with the road being in a direction toward the driver side of the vehicle, the subset of radar sensors includes the front driver-side radar sensor and the rear driver-side radar sensor.

4. The vehicular driving assist system of claim 2, wherein, based on determination that the vehicle is moving from a parallel parking space, and with the road being in a direction toward the passenger side of the vehicle, the subset of radar sensors includes the front passenger-side radar sensor and the rear passenger-side radar sensor.

5. The vehicular driving assist system of claim 2, wherein, based on determination that the vehicle is moving from a perpendicular parking space, and with the road being rearward of the vehicle, the subset of radar sensors includes the rear driver-side radar sensor and the rear passenger-side radar sensor.

6. The vehicular driving assist system of claim 2, wherein, based on determination that the vehicle is moving from a perpendicular parking space, and with the road being forward of the vehicle, the subset of radar sensors includes the front driver-side radar sensor and the front passenger-side radar sensor.

7. The vehicular driving assist system of claim 2, wherein, based on determination that the vehicle is moving from an angled parking space, and with the road being rearward of the vehicle, the subset of radar sensors includes the rear driver-side radar sensor and the rear passenger-side radar sensor.

8. The vehicular driving assist system of claim 2, wherein, based on determination that the vehicle is moving from an angled parking space, and with the road being forward of the vehicle, the subset of radar sensors includes the front driver-side radar sensor and the front passenger-side radar sensor.

9. The vehicular driving assist system of claim 1, wherein the vehicular driving assist system determines that the vehicle is moving from the parking space and toward the road based on determination (i) that a speed of the vehicle is below a threshold speed and (ii) that a steering angle of the vehicle is toward the road.

10. The vehicular driving assist system of claim 9, wherein the threshold speed is zero.

11. The vehicular driving assist system of claim 1, wherein the detected object comprises another vehicle approaching the vehicle.

12. The vehicular driving assist system of claim 1, wherein the generated alert comprises illuminating a turn signal indicator at a side of the vehicle corresponding to the detected object.

13. The vehicular driving assist system of claim 12, wherein, when the turn signal indicator is illuminated based on a user input, the turn signal indicator flashes at a first rate, and wherein the generated alert comprises flashing the turn signal indicator at a second rate that is faster than the first rate.

14. A vehicular driving assist system, the vehicular driving assist system comprising:
a plurality of radar sensors disposed at a vehicle equipped with the vehicular driving assist system, wherein each radar sensor of the plurality of radar sensors senses exterior of the vehicle, and wherein each radar sensor of the plurality of radar sensors is operable to capture sensor data;
wherein the plurality of radar sensors includes at least (i) a front driver-side radar sensor at a front driver-side corner region of the vehicle and sensing exterior of the vehicle and at least forward and along a driver side of the vehicle, (ii) a front passenger-side radar sensor at a front passenger-side corner region of the vehicle and sensing exterior of the vehicle and at least forward and along a passenger side of the vehicle, (iii) a rear driver-side radar sensor at a rear driver-side corner region of the vehicle and sensing exterior of the vehicle and at least rearward and along the driver side of the vehicle, (ii) a rear passenger-side radar sensor at a rear passenger-side corner region of the vehicle and sensing exterior of the vehicle and at least rearward and along the passenger side of the vehicle;
an electronic control unit (ECU);
wherein sensor data captured by the plurality of radar sensors is transferred to the ECU;
wherein the ECU comprises electronic circuitry and associated software;
wherein the electronic circuitry of the ECU comprises a processor for processing sensor data captured by the plurality of radar sensors and transferred to the ECU;
wherein, based on determination that the vehicle is moving from a parking space and toward a road, the vehicular driving assist system processes sensor data captured by a subset of radar sensors of the plurality of radar sensors, and wherein the subset of radar sensors senses exterior of the vehicle and toward the road;
wherein, based on determination that the vehicle is moving from a parallel parking space, and with the road being in a direction toward the driver side of the vehicle, the subset of radar sensors includes the front driver-side radar sensor and the rear driver-side radar sensor;
wherein, based on determination that the vehicle is moving from the parallel parking space, and with the road being in a direction toward the passenger side of the vehicle, the subset of radar sensors includes the front passenger-side radar sensor and the rear passenger-side radar sensor;
wherein, at least in part via processing sensor data captured by the subset of radar sensors, the vehicular driving assist system detects presence of an object approaching vehicle; and
wherein, responsive to detecting presence of the object approaching the vehicle, the vehicular driving assist system generates an alert.

15. The vehicular driving assist system of claim 14, wherein the vehicular driving assist system determines that the vehicle is moving from the parking space and toward the road based on determination (i) that a speed of the vehicle is below a threshold speed and (ii) that a steering angle of the vehicle is toward the road.

16. The vehicular driving assist system of claim 14, wherein the generated alert comprises illuminating a turn signal indicator at a side of the vehicle corresponding to the detected object.

17. The vehicular driving assist system of claim 16, wherein, when the turn signal indicator is illuminated based on a user input, the turn signal indicator flashes at a first rate, and wherein the generated alert comprises flashing the turn signal indicator at a second rate that is faster than the first rate.

18. A vehicular driving assist system, the vehicular driving assist system comprising:
a plurality of radar sensors disposed at a vehicle equipped with the vehicular driving assist system, wherein each radar sensor of the plurality of radar sensors senses exterior of the vehicle, and wherein each radar sensor of the plurality of radar sensors is operable to capture sensor data;
wherein the plurality of radar sensors includes at least (i) a front driver-side radar sensor at a front driver-side corner region of the vehicle and sensing exterior of the vehicle and at least forward and along a driver side of the vehicle, (ii) a front passenger-side radar sensor at a front passenger-side corner region of the vehicle and sensing exterior of the vehicle and at least forward and along a passenger side of the vehicle, (iii) a rear driver-side radar sensor at a rear driver-side corner region of the vehicle and sensing exterior of the vehicle and at least rearward and along the driver side of the vehicle, (ii) a rear passenger-side radar sensor at a rear passenger-side corner region of the vehicle and sensing exterior of the vehicle and at least rearward and along the passenger side of the vehicle;
an electronic control unit (ECU);
wherein sensor data captured by the plurality of radar sensors is transferred to the ECU;
wherein the ECU comprises electronic circuitry and associated software;
wherein the electronic circuitry of the ECU comprises a processor for processing sensor data captured by the plurality of radar sensors and transferred to the ECU;
wherein, based on determination that the vehicle is moving from a parking space and toward a road, the vehicular driving assist system processes sensor data captured by a subset of radar sensors of the plurality of radar sensors, and wherein the subset of radar sensors senses exterior of the vehicle and toward the road;
wherein, based on determination that the vehicle is moving from a perpendicular parking space or an angled parking space, and with the road being rearward of the vehicle, the subset of radar sensors includes the rear driver-side radar sensor and the rear passenger-side radar sensor;
wherein, based on determination that the vehicle is moving from the perpendicular parking space or the angled parking space, and with the road being forward of the vehicle, the subset of radar sensors includes the front driver-side radar sensor and the front passenger-side radar sensor;
wherein, at least in part via processing sensor data captured by the subset of radar sensors, the vehicular driving assist system detects presence of an object approaching vehicle; and
wherein, responsive to detecting presence of the object approaching the vehicle, the vehicular driving assist system generates an alert.

19. The vehicular driving assist system of claim 18, wherein the vehicular driving assist system determines that the vehicle is moving from the parking space and toward the road based on determination (i) that a speed of the vehicle is below a threshold speed and (ii) that a steering angle of the vehicle is toward the road.

20. The vehicular driving assist system of claim 18, wherein the generated alert comprises illuminating a turn signal indicator at a side of the vehicle corresponding to the detected object, and wherein, when the turn signal indicator is illuminated based on a user input, the turn signal indicator flashes at a first rate, and wherein the generated alert comprises flashing the turn signal indicator at a second rate that is faster than the first rate.
